(19) United States
(12) Patent Application Publication
(10) Pub. No.: US 2008/0175442 A1
(43) Pub. Date: Jul. 24, 2008

(54) METHOD OF DISPLAYING GRAPHIC IMAGES

(76) Inventors: Dennis Megarry, Marengo, OH (US); Johan A. Van Zijl, Ashley, OH (US)

Correspondence Address: RONALD J. KOCH, 698 MORRISON RD., SUITE B, COLUMBUS, OH, 43213, US

(21) Appl. No.: 12/017,973

(22) Filed: Jan. 22, 2008

Related U.S. Application Data
(60) Provisional application No. 60/885,925, filed on Jan. 22, 2007.

(51) Int. Cl. G06K 9/00

(52) U.S. Cl. 382/113

(57) ABSTRACT

A method for viewing images comprises: providing a user interactive image file viewing device 100; segmenting an image file 200 by establishing an offset, a line size, and a step size 201, the offset and line size relating to a first dimension (horizontal) and the step size relating to a second dimension (vertical) being orthogonal to the first dimension, the step size comprises a fixed number of lines, iteratively reading the segment into memory line by line beginning at the offset, until the step size is reached 202. In this manner, the sub-part of an image may be efficiently accessed without having to read the entire image into memory.

### CROSS REFERENCE TO RELATED APPLICATIONS

60/885,925

### CLAIM OF PRIORITY BASED ON COPENDING APPLICATION

Claims benefit of provisional application No. 60/885,925, filed on Jan. 22, 2007.

### FEDERALLY SPONSORED RESEARCH

Not Applicable

### SEQUENCE LISTING, TABLE, OR COMPUTER PROGRAM COMPACT DISK APPENDIX

Not Applicable

The present application is related to the co-pending provisional patent application No. 60/885,925, filed on Jan. 22, 2007, of Dennis Megarry, et al., entitled “Method Of Displaying Graphic Images”, and based on which priority is herewith claimed under 35 U.S.C. 119(e) and the disclosure of which is incorporated herein by reference in its entirety as if fully rewritten herein.

### BACKGROUND AND SUMMARY

This invention relates to digital electronic display and document viewing technology, such as the scanning, compression, and dynamic display of charts, graphs, printed documents, and photographs. Particularly, aviation related (FAA-Federal Aviation Administration) materials such as Instrument Approach Procedures, Departure Procedures, Standard Terminal Arrival Charts, Airport Diagrams, Airport/Facilities Directories, High- and Low-level Enroute Charts, and FAR/AIM (Federal Aviation Regulations/Aeronautical Information Manual), IFR Terminal procedure Publications (aka. Approach Charts or Approach plates), Aircraft check lists & Procedures, VFR The invention is particularly advantageous in aeronautical or nautical charting applications, but has other applications. The foregoing images are converted to digitized versions and made available in a small handheld electronic device. Interactive viewing is also provided.

FAA-related materials are traditionally carried in paper or in bulky electronic formats. Average images used in GIS (Geographic Information System) applications are relatively large and do not fit onto smaller devices, at least in raw format. In electronic display formats, light conditions, such as direct sunlight, interfere with reading. Finally, applications running in smaller electronic formats using conventional vector technology require manipulation of often unmanageably large data sets so may be slow and cumbersome in use. In addition, vector images often suffer in the quality of the image delivered to the viewer. Therefore, there is a need for a method of providing large high-quality images in a small electronic format which can be accessed and navigated quickly.

One embodiment of the present invention comprises a method of segmenting a rasterized image by reading the image from a streamed source in such a way as to enable fast access to individual pages of the images without having to load the entire image at once. This is accomplished by reading the image file as if it were a collection of frames of a specific size. The scan line size is determined and the correct step size to use when calculating the height of the image being read is effectively calculated to enable the skipping of segments of the file in which there is no interest. Only a small section of the file is read into memory—normally the size of the screen, plus or minus an overlay area. Additionally, caching is employed to improve extremely large image rendering and navigation. Selective caching is performed around the view area to enable panning left and right with little disruption to the display area.

On average, the images used in a GIS are relatively large and cannot fit on small devices such as the iRex® e-reader (iRex Technologies BV, Eindhoven, the Netherlands) in raw form. The present invention solves this problem by utilizing compression and data presentation that reads an image scan line-by-scan line and extracts only the portion of the image needed. That is, any set rectangle can be extracted from the image by reading a scan line portion and repeating that read until reaching the end of the file. Compression/decompression technologies used to reduce images include MrSID (Multiresolution Seamless Image Database), DjVu (LizardTech, Seattle, Wash.), and JPEG 2000. Geo-referenced information is processed from files to enable mapping file coordinates to geographical coordinates and to enable moving map capabilities.

In operation, only a small section of the file is read into memory; normally the size of the screen plus-minus an overlay area. The steps involved in frame extraction are shown in FIGS. 6 & 7. The “Cacheable” step involves selective caching around the view area to allow a user to pan left and right with little disruption to the display area. Most image files are written in a format that set the first scan line at the top left of the image. However, some image formats differ.

The image width (horizontal) is the length of the scan-line. A horizontal offset (assuming upper left orientation) allows horizontally changing the viewed image. Thus, any rectangle can be extracted from the image by reading a scan line portion and repeating that until the end of the step (vertical) is reached. The foregoing allows for large files, such as raster image files, to be used on small hand held devices. This is particularly useful because raster files have historically not been used in GIS systems, primarily due to their size. The foregoing method allows for the raster files to be used in this context.

The foregoing method is further enhanced by using selective caching whereby adjacent or peripheral image portions (to the view area) are read into memory to allow the user to pan left and right with little disruption to the display area.

Various third party technologies are incorporated to implement the foregoing method: listed by company name—technology: LizardTech—DJVU, LizardTech—MrSid, JPEG Org—JPEG 2000, Apple—WebCore, Mozilla—Minimo, and Png.org—PNM/PMB.

The present invention is particularly useful in images files utilized by pilots: US VFR Sectionals, IFR Enroute Charts, and Terminal Procedure Publications, PDA Plates, and PDA Sectionals, to name a few. In one embodiment, the original image files provided by the National Aeronautical Charting Office (NACO) are compressed to 1/10th their original size. This allows for critical flight data to be added to devices where storage is at a premium.

The invention is not dependant on any one display platform. However, certain platforms are advantageous. For example, display technologies that operate well in high ambient light (e.g. sunlight in an airplane cockpit) environments are preferred. “e-ink” and OLED are sunlight readable platforms and are preferred.

Accordingly, some embodiments of the invention incorporate technology commonly referred to as e-ink (Electronic Ink, aka “electronic paper”) displays—A process of electronically charging molecules to generate an image onto a display screen. The present invention can be used with black and white or color e-ink displays. Electronic paper has also been described as using electric charge to make tiny particles of dye rise to the surface of a screen forming crisp letters or images. Electronic paper does not require a backlight.

The invention is not dependant on any one operating system platform. It can be implemented on Windows, Linux/UNIX, and Pocket PC, to name a few.

One embodiment comprises a method for efficiently viewing large images comprising segmentation of an image by reading it from a streamed source in such a way as to allow quick and easy access to “individual pages” of the images without having to load the whole image at once. This is done by reading the image file as if it's simply a collection of frames of a specific size, starting at an offset, the scan line size is determined (horizontal), then the correct step size is calculated based on the height (vertical).

It is to be understood that “streamed source” as used herein includes the sequential reading of an electronic file as it is being read from a storage medium and that “individual pages” as used herein refers that segment of a large image that is desired to be viewed.

### BRIEF DESCRIPTION OF THE DRAWINGS

FIG. 1 depicts a block diagram of a user interactive image file viewing device 100

FIG. 2 depicts a flow diagram of segmenting an image file 200

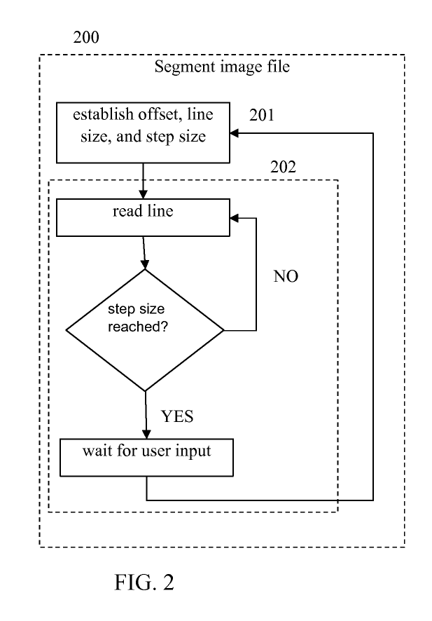

FIG. 3 depicts a flow diagram of segmenting an image file 200A

FIG. 4 depicts a block diagram of a user interactive image file viewing device 100A

FIG. 5 depicts a block diagram of a user interactive image file viewing device 100B

FIG. 6 depicts a flow diagram of an alternative embodiment

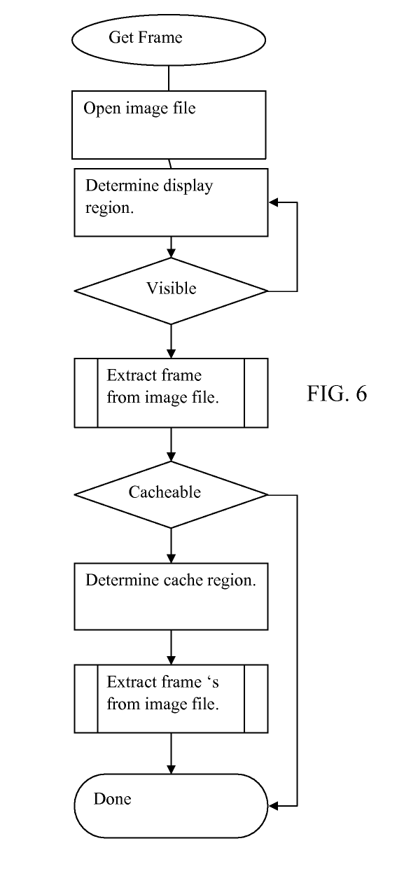

FIG. 7 depicts a flow diagram of an alternative embodiment

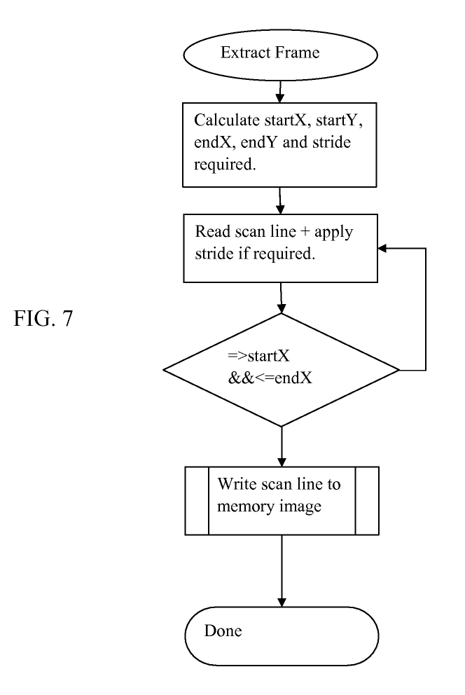

### DETAILED DESCRIPTION

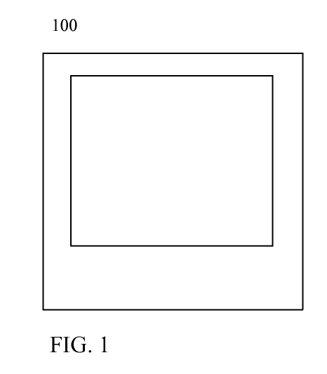

In one embodiment (FIGS. 1 & 2), a method for viewing images comprises: providing a user interactive image file viewing device 100; segmenting an image file 200 (i.e. determining the portion of the image to be viewed) by establishing an offset, a line size, and a step size 201, the offset and line size relating to a first dimension (horizontal) and the step size relating to a second dimension (vertical) being orthogonal to the first dimension, the step size comprises a fixed number of lines, iteratively reading the segment into memory 202 line by line beginning at the offset, until the step size is reached. In this manner, the sub-part of an image (i.e. the portion of the image to be viewed) may be efficiently accessed without having to read the entire image into memory. It is to be understood that “user interactive image file viewing device” as used herein can include personal digital assistants (PDA's), or e-reader devices.

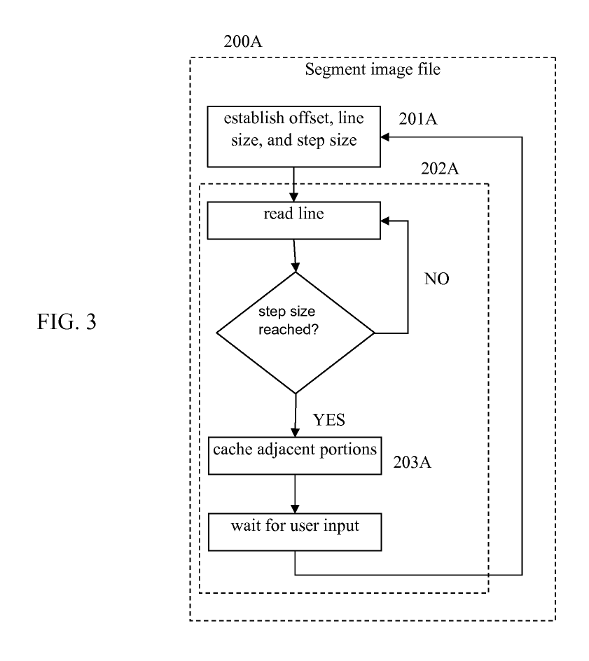

In some embodiments, (FIG. 3) adjacent or peripheral portions of the image are cached into memory 203A in anticipation of the user panning the image. Thus, those portions of the image are already loaded into memory so the image can be panned more quickly. As will be apparent, the entire periphery of a given segment can be cached or only some portions. Although preferred, the invention can function without caching.

In some embodiments, the image file comprises a geographic image. For example, images relating to GIS (geographic information system) images.

In one embodiment, the image being viewed is representative of geography and is synchronized to the actual geographic location of the viewing device. This is typified in an application wherein the device is being used by a pilot who is viewing a map of that portion of the earth over which he or she is flying.

The interactive image file viewing device is equipped with GPS capabilities and can therefore ascertain its position. This information is synchronized with the map and the image is panned (or moved) as the airplane moves. Thus, the pilot can always view a map representative of where the plane is.

In one embodiment, the image file is a compressed file. In one embodiment, the image file is a raster file. The file could also be a vector based image. In other embodiments, the images being viewed are of the type utilized by pilots. For example, approach plates and Enroutes. Other embodiments comprise different combinations of file types, such as a compressed raster file, a compressed raster file representative of a geographic image, or a compressed raster file representative of a GIS image.

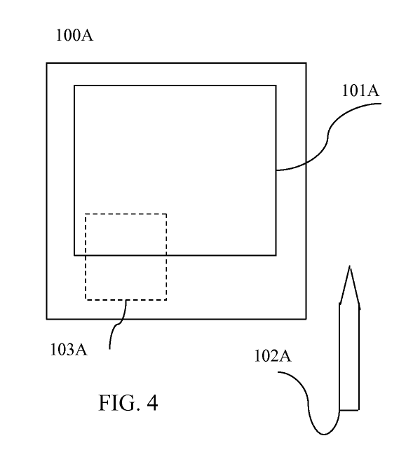

In some embodiments (FIG. 4), the user interactive image file viewing device 100A comprises display means 101A for viewing an image file; user input means 102A comprising a pointer device; and a computer processor and memory 103A effective to, load a least a portion of an image file into memory, the memory being operatively coupled to the display means, and receive user input. In one embodiment, the display means incorporates electronic paper.

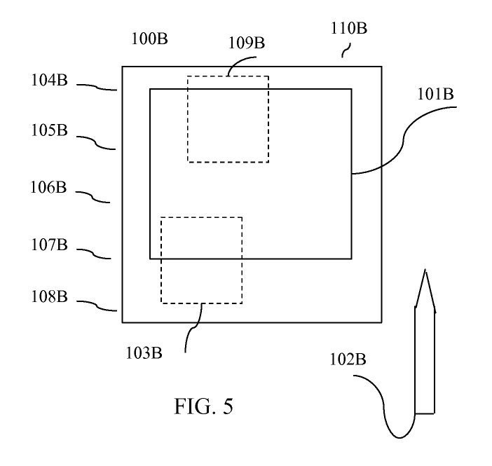

In one embodiment (FIG. 5), a system for viewing images comprises: a USB type A connector (104B) for USB memory stick; a CF type II slot (105B); a SD card slot (106B); a 3.5 mm stereo audio jack (107B) for headset; WIFI 802.11g wireless LAN capability (not shown); 10/100 MB wired LAN capability (108B); an 8.1 inch electronic paper display (101B) comprises dimensions of 4.8″×6.4″, 768×1024 pixels, and displays 16 levels of gray; a computer processor and memory (103B) comprising: a 400 MHz computer Processor, 64 MB Ram, and 256 MB memory (128 MB of which being available for content and expandable via external slots); the computer processor and memory 103B being effective to enable the system to perform the steps of, segmenting an image file by establishing an offset, a line size, and a step size, the offset and line size relating to a first dimension and the step size relating to a second dimension being orthogonal to the first dimension, the step size comprises a fixed number of lines, iteratively reading the segment into memory line by line beginning at the offset, until the step size is reached, the image file being a compressed raster file representative of a geographic image, reading into memory an adjacent portion of a selected image segment; touch sensor input using stylus 102B; rechargeable battery 109B; polyphonic speaker 110B; the system having dimensions of 6.1″ wide×8.5 high×0.6 deep; the system having weight of 13.7 oz; the system having an operating temperature range of between 32° f; to 122° f., and the system having a storage temperature range of −4° f to 158° f.

What is claimed is:

1. A method for viewing images comprising:
providing a user interactive image file viewing device;
segmenting an image file by
establishing an offset, a line size, and a step size, the offset and line size relating to a first dimension and the step size relating to a second dimension being orthogonal to the first dimension, the step size comprising a fixed number of lines,
iteratively reading the segment into memory line by line beginning at the offset, until the step size is reached;
whereby sub-parts of an image may be efficiently accessed without having to read the entire image into memory.

2. The method of claim 1 wherein
an adjacent portion of a selected image segment is read into memory;
whereby the image segment may be efficiently panned.

3. The method of claim 1 wherein
an entire peripheral portion of a selected image segment is read into memory;
whereby the image segment may be efficiently panned.

4. The method of claim 1 wherein
the image file comprises a geographic image;
the image file viewing device being operative to ascertain the geographic position thereof,
a segment representing a sub -part of the geographic image is read into memory,
the segment being actively synchronized to the geographic location of the viewing device.

5. The method of claim 1 wherein
the image file is a compressed file.

6. The method of claim 1 wherein
the image file is an approach plate.

7. The method of claim 1 wherein
the image file is an Enroute.

8. The method of claim 1 wherein
the image file is a raster file.

9. The method of claim 1 wherein
the image file is a compressed raster file.

10. The method of claim 1 wherein
the image file is a compressed raster file representative of a geographic image.

11. The method of claim 1 wherein
the image file is a compressed raster file representative of a GIS image.

12. The method of any one of claims 2 through 11 wherein the user interactive image file viewing device comprises:
display means for viewing an image file;
user input means;
a computer processor and memory effective to,
load a least a portion of an image file into memory, the memory being operatively coupled to the display means,
receive user input.

13. The method of claim 12 wherein
the display means incorporates electronic paper.

14. A method for viewing images comprising:
providing a user interactive image file viewing device comprising,
display means for viewing an image file,
user input means,
a computer processor and memory effective to,
load a least a portion of an image file into memory, the memory being operatively coupled to the display means,
receive user input;
segmenting an image file by
establishing an offset, a line size, and a step size, the offset and line size relating to a first dimension and the step size relating to a second dimension being orthogonal to the first dimension, the step size comprising a fixed number of lines;
iteratively reading the segment into memory line by line beginning at the offset, until the step size is reached;
the image file being a compressed raster file representative of a geographic image;
whereby sub-parts of an image may be efficiently accessed without having to read the entire image into memory.

15. The method of claim 14 wherein
the display means incorporates electronic paper.

16. The method of claim 14 wherein
an adjacent portion of a selected image segment is read into memory;
whereby the image segment may be efficiently panned.

17. The method of claim 14 wherein
an entire peripheral portion of a selected image segment is read into memory;
whereby the image segment may be efficiently panned.

18. A system for viewing images comprising:
a USB type A connector for USB memory stick;
a CF type II slot;
a SD card slot;
a 3.5 mm stereo audio jack for headset;
WIFI 802.11g wireless LAN capability;
10/100 MB wired LAN capability;
an 8.1 inch electronic paper display comprising
having dimensions of 4.8″×6.4″,
768×1024 pixels,
16 levels of gray;
a 400 MHz computer Processor;
computer memory comprising,
64 MB Ram,
256 MB memory, 128 MB of which being available for content and expandable via external slots;
the computer processor and memory being effective to enable the system to perform the steps of,
segmenting an image file by
establishing an offset, a line size, and a step size, the offset and line size relating to a first dimension and the step size relating to a second dimension being orthogonal to the first dimension, the step size comprising a fixed number of lines,
iteratively reading the segment into memory line by line beginning at the offset, until the step size is reached,
the image file being a compressed raster file representative of a geographic image,
reading into memory an adjacent portion of a selected image segment;
touch sensor input using stylus;
rechargeable battery;
polyphonic speaker;
the system having dimensions of 6.1″ wide×8.5 high×0.6 deep;
the system having weight of 13.7 oz;
the system having an operating temperature range of between 32° f to 122° f;
the system having a storage temperature range of −4° f to 158° f.
